(19) United States
(12) Patent Application Publication
(10) Pub. No.: US 2018/0154902 A1
(43) Pub. Date: Jun. 7, 2018

(54) VEHICLE CONTROL USING ROAD ANGLE DATA

(71) Applicant: GM GLOBAL TECHNOLOGY OPERATIONS LLC, Detroit, MI (US)

(72) Inventor: CONSTANDI J. SHAMI, ANN ARBOR, MI (US)

(73) Assignee: GM GLOBAL TECHNOLOGY OPERATIONS LLC, Detroit, MI (US)

(21) Appl. No.: 15/370,064

(22) Filed: Dec. 6, 2016

(51) Int. Cl. B60W 40/076; G01S 19/13; G01C 21/28; B60W 10/20; B60W 10/18

(52) U.S. Cl. CPC B60W 40/076; G01S 19/13; G01C 21/28; B60W 10/20; B60W 10/18; B60W 2720/106; B60W 2420/42; B60W 2420/52; B60W 2710/20; B60W 2710/18; B60W 2550/142

(57) ABSTRACT

Vehicles, vehicle control systems and methods are provided for controlling a vehicle function. An acceleration component of a vehicle is measured. One or both of road gradient and road bank angle of a road being travelled by the vehicle are obtained. The vehicle function is controlled responsive to the acceleration component of the vehicle and the one or both of road gradient and bank angle.

### TECHNICAL FIELD

The present disclosure generally relates to autonomous vehicle control and more particularly relates to use in vehicle control of road angle data to compensate for gravity influence in measured acceleration data.

### BACKGROUND

This section provides background information related to the present disclosure which is not necessarily prior art.

Modern vehicles include various autonomous control features. These features assist the driver in, for example, braking, steering and engine power control by using sensed data from a variety of sources as part of complex control algorithms. In development are vehicles allowing ever less involvement of the driver in operation of the vehicle.

Such autonomous control functions are reliant on accuracy of sensed data. One source of sensed data in many vehicles is an inertial measurement unit, which provides data on various components of vehicle acceleration. Automated control processes in the vehicle rely on the acceleration data.

Accordingly, it is desirable to account for any unintended false influences of acceleration data from the inertial measurement unit. In addition, it is desirable to control automated vehicle functions based on accurate sensor data. Furthermore, other desirable features and characteristics of the present invention will become apparent from the subsequent detailed description and the appended claims, taken in conjunction with the accompanying drawings and the foregoing technical field and background.

### SUMMARY

A vehicle is provided having a controlled vehicle function. In one embodiment, the vehicle includes a vehicle control system. The vehicle control system includes an inertial measurement unit including a sensor for measuring a measured acceleration component of a vehicle. A processor is configured to obtain one or both of road gradient and road bank angle of a road being travelled by the vehicle. The processor is configured to control the vehicle function responsive to the acceleration component of the vehicle and the one or both of road gradient and bank angle.

A vehicle control system is provided for controlling a vehicle function. In one embodiment, the vehicle control system includes an inertial measurement unit including a sensor for measuring a measured acceleration component of a vehicle. A processor is configured to obtain one or both of road gradient and road bank angle of a road being travelled by the vehicle. The processor is configured to control the vehicle function responsive to the acceleration component of the vehicle and the one or both of road gradient and bank angle.

A method is provided for controlling a function of a vehicle. In one embodiment, the method includes measuring a measured acceleration component of a vehicle. The method includes obtaining one or both of road gradient and road bank angle of a road being travelled by the vehicle. The method includes controlling the vehicle function responsive to the acceleration component of the vehicle and the one or both of road gradient and bank angle.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a vehicle control system for operating various autonomous vehicle control functions and sensors for sensing road angles, in accordance with an exemplary embodiment;

FIG. 2 is functional block diagram of the vehicle of FIG. 1 traversing a road with a gradient in a longitudinal direction, in accordance with an exemplary embodiment;

FIG. 3 is a functional block diagram of the vehicle of FIG. 1 traversing a road with a gradient in a lateral direction, in accordance with an exemplary embodiment;

FIG. 4 is a functional block diagram of system modules for determining an offset acceleration based on an obtained road angle and controlling an autonomous vehicle function based on the offset acceleration, in accordance with an exemplary embodiment;

FIG. 5 is a data flow diagram representing a method and system of determining an offset acceleration based on an obtained road angle and controlling an autonomous vehicle function based on the offset acceleration, in accordance with an exemplary embodiment; and

FIG. 6 is a is a flowchart of a method for determining an offset acceleration based on an obtained road angle and controlling an autonomous vehicle function based on the offset acceleration, in accordance with an exemplary embodiment.

FIG. 7 is an image including horizontal and road gradient angle markers for determining road angle, in accordance with an exemplary embodiment.

FIG. 8 is an image including horizontal and road banking angle markers for determining road angle, in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

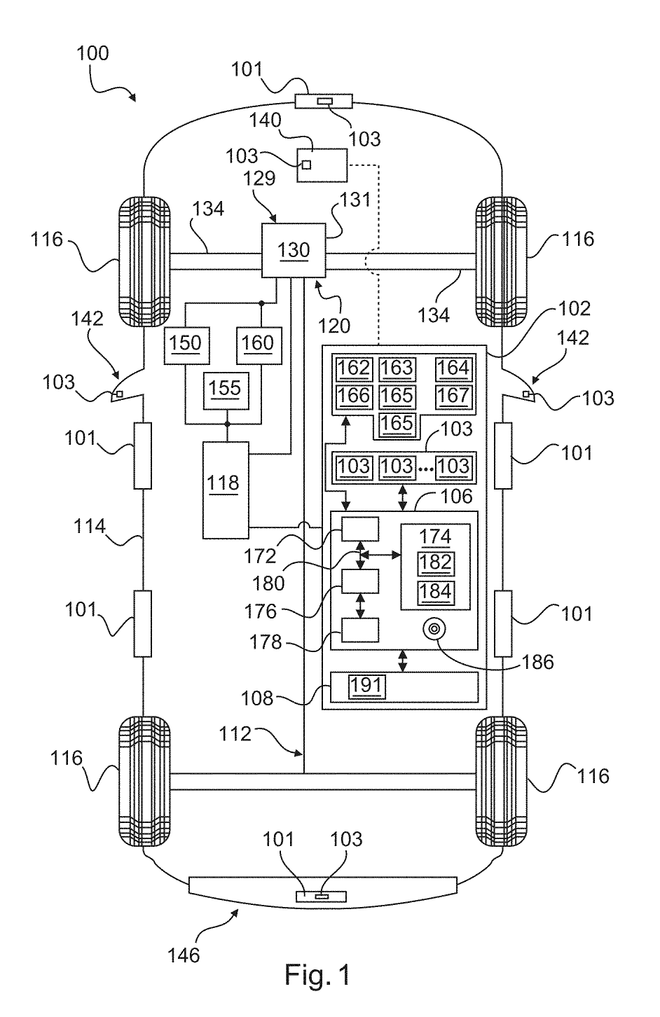

FIG. 1 illustrates a vehicle 100, or automobile, according to an exemplary embodiment. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

As described in greater detail further below, and according to an exemplary embodiment, the vehicle 100 includes various cameras 101, 103 and/or other sensors 167 from which road angle can be derived as well as a vehicle control system 102 for determining at least one acceleration offset and controlling at least one vehicle function based on the at least one acceleration offset. In the depicted embodiment, the cameras include visual cameras 103 and lidar cameras 101 distributed around the vehicle including at front, rear and both sides of the vehicle 100. Other imaging devices than visual and lidar cameras may be utilized. The cameras may obtain video data, which includes images obtained at a high frame rate, or lower time frequency images. It will be appreciated that the number and/or location of cameras 101, 103 may vary in different embodiments. The other sensors 167 may include at least one level sensor arranged to measure longitudinal and/lateral road angle, i.e. longitudinal road gradient and/or road banking angle.

Also as discussed further below, the vehicle control system 102 includes a controller 106. In various embodiments, the vehicle control system 102 provides determination of acceleration offset and autonomous vehicle control functions based thereon, as set forth in greater detail further below in connection with the discussion of FIGS. 3, 4 and 5.

In one embodiment depicted in FIG. 1, vehicle 100 includes, in addition to the above-referenced cameras 101, 103, and vehicle control system 102, a chassis 112, a body 114, four wheels 116, an electronic system 118, a powertrain 129, a rear view mirror 140, side mirrors 142, a front grill 144, a steering system 150, a braking system 155, and a power system 160. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. As depicted in FIG. 1, each wheel 116 comprises a wheel assembly that includes a tire as well as a wheel and related components (and that are collectively referred to as the “wheel 116” for the purposes of this application). In various embodiments, the vehicle 100 may differ from that depicted in FIG. 1. For example, in certain embodiments the number of wheels 116 may vary. By way of additional example, in various embodiments the vehicle 100 may not have a steering system, and for example may be steered by differential braking, among various other possible differences.

In the exemplary embodiment illustrated in FIG. 1, the powertrain 129 includes an actuator assembly 120 that includes an engine 130. In various other embodiments, the powertrain 129 may vary from that depicted in FIG. 1 and/or described below (e.g. in some embodiments the powertrain may include a gas combustion engine 130, while in other embodiments the powertrain 129 may include an electric motor, alone or in combination with one or more other powertrain 129 components, for example for electric vehicles, hybrid vehicles, and the like). In one embodiment depicted in FIG. 1, the actuator assembly 120 and the powertrain 129 are mounted on the chassis 112 that drives the wheels 116. In one embodiment, the engine 130 comprises a combustion engine, and is housed in an engine mounting apparatus 131. In various other embodiments, the engine 130 may comprise an electric motor and/or one or more other transmission system 129 components (e.g. for an electric vehicle).

It will be appreciated that in other embodiments, the actuator assembly 120 may include one or more other types of engines and/or motors, such as an electric motor/generator, instead of or in addition to the combustion engine. In certain embodiments, the electronic system 118 comprises an engine system that controls the engine 130 and/or one or more other systems of the vehicle 100.

Still referring to FIG. 1, in one embodiment, the engine 130 is coupled to at least some of the wheels 116 through one or more drive shafts 134. In some embodiments, the engine 130 is mechanically coupled to the transmission. In other embodiments, the engine 130 may instead be coupled to a generator used to power an electric motor that is mechanically coupled to the transmission. In certain other embodiments (e.g. electrical vehicles), an engine and/or transmission may not be necessary.

The steering system 150 is mounted on the chassis 112, and controls steering of the wheels 116. In one embodiment, the steering system 150 may include a non-depicted steering wheel and a steering column. In various embodiments, the steering wheel receives inputs from a driver of the vehicle 100, and the steering column results in desired steering angles for the wheels 116 via the drive shafts 134 based on the inputs from the driver. In certain embodiments, an autonomous vehicle may utilize steering commands for the steering system 150 that are generated by the vehicle control system 102, with no involvement from the driver. In other embodiments, the steering system 150 receives commands from both the user and the vehicle control system 102 in a semi-autonomous implementation. In other embodiments, the vehicle control system 102 controls at least one function of the steering system 150 responsive to acceleration and at least one of road gradient and bank angle, as will be described further herein. For example, the vehicle control system 102 may generate a steering control command using offset acceleration, where offset acceleration is determined as described further herein.

The braking system 155 is mounted on the chassis 112, and provides braking for the vehicle 100. In an embodiment, the braking system 155 receives inputs from the driver via a non-depicted brake pedal, and provides appropriate braking via brake units (not depicted). In certain embodiments, an autonomous vehicle may utilize braking commands for the braking system 155 that are generated by the vehicle control system 102, with no involvement from the driver. In other embodiments, the steering system 150 receives commands from both the user and the vehicle control system 102 in a semi-autonomous implementation. In other embodiments, the vehicle control system 102 controls at least one function of the braking system 155 responsive to acceleration and at least one of road gradient and bank angle, as will be described further herein. For example, the vehicle control system 102 may generate a braking control command using offset acceleration, where offset acceleration is determined as described further herein.

The power system 160 is mounted on the chassis 112, and provides power control of the vehicle 100 with the set power representative of a desired speed or acceleration of the vehicle 100. The power system 160 communicates with the powertrain 129 in order to control power delivered to the driveshafts 134. For example, the power system 160 may include an acceleration input system comprising an accelerator pedal 161 that is engaged by a driver, with the engagement representative of a desired speed or acceleration of the vehicle 100. In certain embodiments, an autonomous vehicle may utilize power commands for the power system 160 that are generated by the vehicle control system 102, with no involvement from the driver so as to provide automated speed and acceleration control. In other embodiments, the power system 160 receives commands from both the user and the vehicle control system 102 in a semi-autonomous implementation. In other embodiments, the vehicle control system 102 controls at least one function of the power system 160 responsive to acceleration and at least one of road gradient and bank angle, as will be described further herein.

As noted above and depicted in FIG. 1, in one embodiment the vehicle control system 102 comprises a plurality of LIDAR, visual and/or other imaging modality cameras 101, 103 and/or at least one level sensor 167 as part of a sensor array 104, and a controller 106. While the components of the vehicle control system 102 (including the cameras 101, 103, the sensor array 104, and the controller 106) are depicted as being part of the same system, it will be appreciated that in certain embodiments these features may comprise two or more systems. In addition, in various embodiments the control system 102 may comprise all or part of, and/or may be coupled to, various other vehicle devices and systems, such as, among others, the actuator assembly 120, the electronic system 118, and/or one or more other systems of the vehicle 100.

The plurality of cameras 101, 103 obtain images with respect to various different locations of the vehicle 100. In addition, in various embodiments, the cameras 101,103 also obtain images with respect to surroundings, including objects, in proximity to the vehicle 100, surrounding roads, and surrounding road features such as building, curbs, roadside banks, etc. As depicted in one embodiment, cameras 101, 103 are included within or proximate each of the rear view mirror 140, side mirrors 142, front grill 144, and rear region 146. In one embodiment, the cameras 101, 103 comprise video cameras controlled via the controller 106. In various embodiments, the cameras 103 may also be disposed in or proximate one or more other locations of the vehicle 100. The cameras 101 represent LIDAR cameras or sensors, in the present embodiment. The cameras 103 represent visual cameras, e.g. cameras operating in the visible, infrared or ultraviolet ranges using ambient light. Other imaging devices are possible than LIDAR and visual cameras.

The sensor array 104 includes various sensors (also referred to herein as sensor units) that are used for providing measurements and/or data for use by the controller 106. In embodiments, the sensor array 104 includes at least one level sensor 167 that is able to measure, electronically, longitudinal and/or lateral angle of the car relative to horizontal. Exemplary implementations of the at least one level sensor (also known as an inclinometer) would be an electrolytic tilt sensor, an accelerometer, a liquid capacitive device, a gas bubble in liquid device, a pendulum device, a Micro Electro Mechanical Sensor, MEMS, tilt sensor, etc. In embodiments, a two-axis digital inclinometer is included so that both lateral and longitudinal road incline relative to horizontal can be measured.

In exemplary embodiments, the sensor array 104 includes an inertial measurement unit 166 including at least one accelerometer as a sensor for measuring acceleration of the vehicle. The inertial measurement unit 166 is configured to obtain various acceleration readings including longitudinal, vertical and lateral acceleration. In various embodiments, the inertial measurement unit is a self-contained system that measures linear and angular motion usually with a triad of gyroscopes and triad of accelerometers. The inertial measurement unit can be gimballed or strapdown and is configured for outputting quantities of angular velocity and acceleration of the vehicle 100. The vehicle control system 102 is configured to autonomously control various vehicle functions, such as steering, braking and power as described above with respect to the steering, braking and power systems 150, 155, 160, based on, at least in part, acceleration measurements from the inertial measurement unit 166. That is, at least one vehicle command may be generated based on a control algorithm or calculation that incorporates acceleration readings from the inertial measurement unit 166. Road slope in the lateral and longitudinal direction can falsely affect the acceleration readings, which can thus result in false control maneuvers. Embodiments of the present disclosure obtain the road angle for road gradient and/or road bank and utilize this information in controlling at least on vehicle function, thereby alleviating any false control maneuvers that might otherwise have occurred.

In exemplary embodiments, the sensor array 104 includes a GPS navigation device or GPS receiver 168. The GPS receiver 168 is a device that is capable of receiving information from GPS satellites. Based on the GPS information, the receiver 168 is capable of calculating its geographical location. The GPS receiver may use assisted GPS (A-GPS) technology by which telecommunications base stations and/or cell towers provide device location tracking capability. The GPS receiver 168 is configured for providing global positioning data for use in locating the vehicle with respect to an enhanced digital map 184 as described further below.

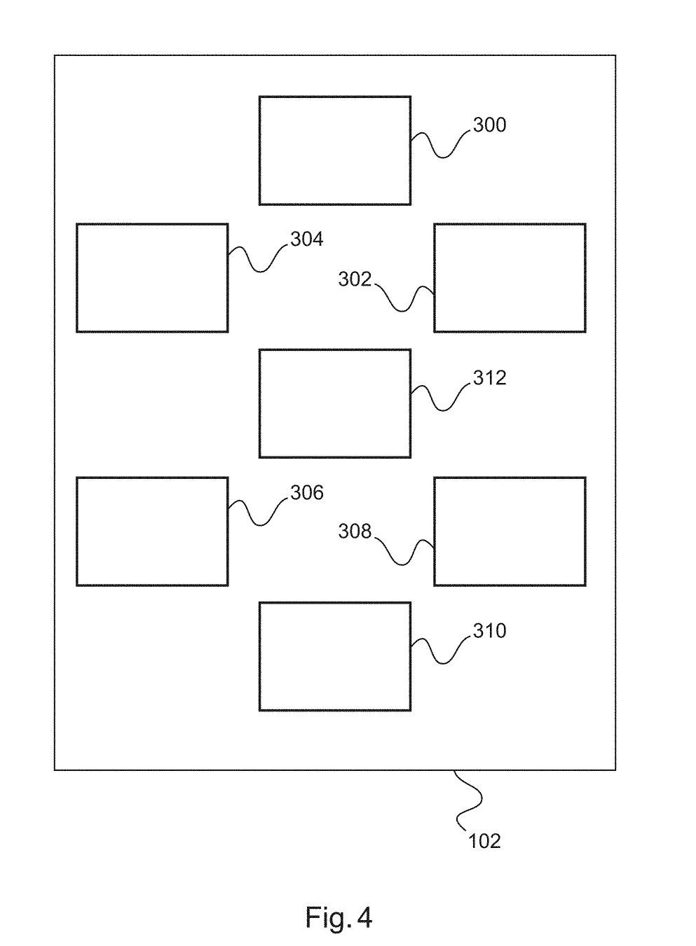

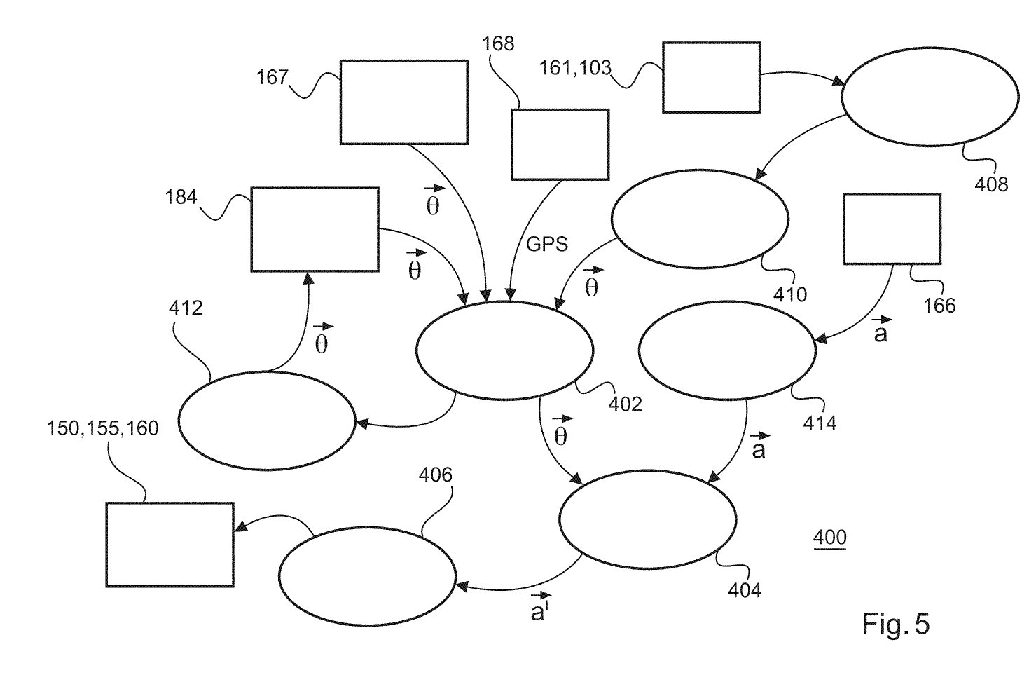

In various embodiments, the sensors of the sensor array 104 comprise one or more detection sensors 162, interface sensors 163, gear sensors 164, and/or wheel speed sensors 165. The detection sensors 162 (e.g. radar, lidar, sonar, machine vision, Hall Effect, and/or other sensors) detect objects in proximity to the vehicle 100. The interface sensors 163 detect a user's engagement of an interface of the vehicle 100 (e.g. a button, a knob, a display screen, and/or one or more other interfaces). The gear sensors 164 detect a gear or transmission state of the vehicle 100 (e.g. park, drive, neutral, or reverse). The wheel speed sensors 165 measure a speed of one or more of the wheels 116 of the vehicle 100. In various embodiments, the sensor array 104 provides the measured information to the controller 106 for processing, including for determining acceleration offset based on road angle in accordance with the steps of the methods and systems described with respect to FIGS. 4 and 5. It will be appreciated that in certain embodiments the cameras 101, 103 may be considered as part of the sensor array 104.

As depicted in FIG. 1, the controller 106 comprises a computer system. In certain embodiments, the controller 106 may also include one or more of the sensors of the sensor array 104, one or more other devices and/or systems, and/or components thereof. In addition, it will be appreciated that the controller 106 may otherwise differ from the embodiment depicted in FIG. 1. For example, the controller 106 may be coupled to or may otherwise utilize one or more remote computer systems and/or other systems, such as the electronic system 118 of the vehicle 100, and/or one or more other systems of the vehicle 100.

In the depicted embodiment, the computer system of the controller 106 includes a processor 172, a memory 174, an interface 176, a storage device 178, and a bus 180. The processor 172 performs the computation and control functions of the controller 106, and may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs 182 contained within the memory 174 and, as such, controls the general operation of the controller 106 and the computer system of the controller 106, generally in executing the methods and systems described further below in connection with FIGS. 4 and 5.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores the above-referenced program 182 along with one or more stored maps 184. In certain embodiments, the stored maps 184 are enhanced digital maps 184 including a collection of data compiled and formatted into a virtual image. The enhanced digital maps provide representations of a particular area, detailing roads, terrain encompassing the surrounding area and other points of interest. The enhanced digital map 174 allows the calculation of distances from one place to another. The enhanced digital map 174 is used with the Global Positioning System, or GPS satellite network, as part of an automotive navigation system. The enhanced digital map may also include traffic updates, service locations and other enhancement data for the user. Further, the enhanced digital map 174 includes, in embodiments, a layer of road angle data representing angle of longitudinal and/or lateral road inclination (e.g. road gradient and road banking angle). In other embodiments, the enhanced digital map 174 includes a layer of road images from which road angle data can be derived through image analysis. The enhanced digital map 174 may include data sets for virtual maps, satellite (aerial views) views, and hybrid (a combination of virtual map and aerial views) views. The enhanced digital maps 174 may be defined in a GIS file format, which is a standard of encoding geographical information into a computer file. The enhanced digital map 174 may be accessed by the vehicle control system for various functions including extracting road angle data as described further herein, and for satellite navigation. The enhanced digital map 174, and a satellite navigation system computer program, of the vehicle control system 102 may be stored in memory 174 located in the vehicle 100 or in cloud storage. Cloud computing may be utilized as part of the vehicle control system 102 for various functions described herein, including obtaining road angle data from the enhanced digital maps 174 and satellite navigation.

The bus 180 serves to transmit programs, data, status and other information or signals between the various components of the computer system of the controller 106. The interface 176 allows communication to the computer system of the controller 106, for example from a system driver and/or another computer system, and can be implemented using any suitable method and apparatus. In one embodiment, the interface 176 obtains the various data from the sensors of the sensor array 104. The interface 176 can include one or more network interfaces to communicate with other systems or components. The interface 176 may also include one or more network interfaces to communicate with technicians, and/or one or more storage interfaces to connect to storage apparatuses, such as the storage device 178.

The storage device 178 can be any suitable type of storage apparatus, including direct access storage devices such as hard disk drives, flash systems, floppy disk drives and optical disk drives. In one exemplary embodiment, the storage device 178 comprises a program product from which memory 174 can receive a program 182 that executes one or more embodiments of one or more processes and systems of the present disclosure, such as the features described further below in connection with FIGS. 4 and 5. In another exemplary embodiment, the program product may be directly stored in and/or otherwise accessed by the memory 174 and/or a disk (e.g., disk 186), such as that referenced below.

The bus 180 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 106 may also otherwise differ from the embodiment depicted in FIG. 1, for example in that the computer system of the controller 106 may be coupled to or may otherwise utilize one or more remote computer systems, e.g. cloud computing, and/or other systems.

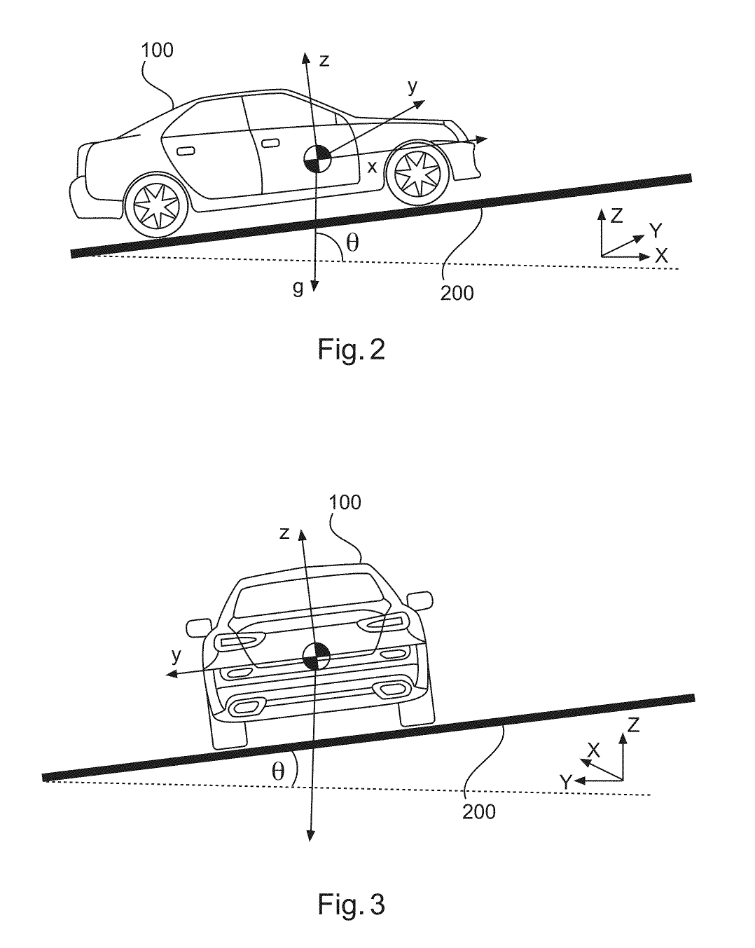

FIG. 2 is a view of the vehicle 100 on a road having an upwardly inclined slope, in accordance with an exemplary embodiment. That is, the road 200 has a positive gradient along a longitudinal or x direction of travel. The road 200 defines an angle θₓ with respect to horizontal along the longitudinal axis x. A downward slope would have a negative longitudinal road gradient. FIG. 3 is a view of the vehicle 100 on a road 200 having a lateral slope, in accordance with an exemplary embodiment. That is, the road 200 has a banking incline along a lateral or y direction. The road 200 defines an angle θ_{y} with respect to horizontal along the lateral axis y. A vector angle \vec{θ} is used herein to reference the vector of road angle including longitudinal and lateral components.

In FIG. 2, the acceleration g due to gravity, for a vehicle 100 traversing a road gradient, contributes to longitudinal, x, and vertical, z, acceleration components aₓ and a_{z}, respectively. The gravity affected acceleration components aₓ and a_{z} are measured by the inertial measurement unit 166. In order to remove, or at least partially compensate for, the gravity contribution, the following equations may be used:

a′ₓ=aₓ₋g cos θₓ (equation 1)

a′_{z}=a_{z-g} sin θₓ (equation 2)

where a′ₓ and a′_{z} represents offset or compensated acceleration components in the longitudinal and vertical directions x and z.

In FIG. 3, the acceleration g due to gravity, for a vehicle 100 traversing a road having a banking angle, contributes to lateral, y, and vertical, z, acceleration components aₓ and a_{z}, respectively. The gravity affected acceleration components a_{y} and a_{z} are measured by the inertial measurement unit 166. In order to remove, or at least partially compensate for, the gravity contribution, the following equations may be used:

$$\begin{matrix}{a}_{z}^{′} = a - \frac{g}{cos {θ}_{y}} & ( equation 3 ) \\ {a}_{y}^{′} = a + g tan {θ}_{y} & ( equation 4 )\end{matrix}$$

where a′_{y} and a′_{z} represents offset or compensated acceleration components in the lateral and vertical directions y and z.

The present disclosure proposes to determine at least one of the road angle components θₓ and θ_{y}, to determine at least one offset acceleration component a′_{x, y and/or z} based on the road angle components and at least one measured acceleration component a_{x, y and/or z} and to control at least one vehicle function based on the at least one offset acceleration component. Systems and methods are described herein, particularly with reference to FIGS. 4 to 6 for performing such operations.

FIG. 4 is a block diagram showing exemplary, and schematic, modules of the vehicle control system 102. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. The modules of FIG. 4 are connected by the bus 180 to allow data communication therebetween. The modules of FIG. 4 may be implemented by the processor 172 operating on computer program instructions stored on the non-transitory computer readable medium 174. It should be appreciated that processing capabilities of the processor 172 and storage capabilities of the computer readable medium can be located in the vehicle 100, in a remote server or distributed therebetween. Although separate modules are shown in FIG. 4, these modules can be further sub-divided or combined.

In the exemplary embodiment of FIG. 4, there is shown a data receiving module 300 that includes at least one data interface for receiving data from various sources. In embodiments, the data receiving module 300 is configured to receive map data from the enhanced digital map 184. In embodiments, the data receiving module 300 is configured to receive GPS data from the GPS receiver 168. In embodiments, the data receiving module 300 is configured to receive acceleration data, \vec{a}, from the inertial measurement unit 166. In embodiments, the data receiving module 300 is configured to receive image or video data from the cameras 101, 103. In embodiments, the data receiving module 300 is configured to receive tilt data from the level sensor 167. The data receiving module 300 may include a bus interface for communicating the received data to other modules over the bus 180. The data receiving module 300 may include a processor for processing the data into a required format and for directing the data to other modules as required.

Continuing to refer to the exemplary embodiment of FIG. 4, there is shown an offset acceleration determination module 306. In embodiments, the offset acceleration determination module 306 includes an input interface configured to receive data representative of longitudinal and/or lateral road angle (that is, road gradient angle and/or road banking angle) relative to horizontal, e.g. \vec{θ}. The road angle data \vec{θ} can be obtained from various sources. For example, the road angle data \vec{θ} can be obtained through data from the level sensor 167, through data extracted from image or video data from the cameras 101, 103 (as described in more detail below) or from the enhanced digital map 184, through data extracted from the enhanced digital map 184. In embodiments, the offset acceleration determination module 306 is configured to receive acceleration data, \vec{a}, obtained through the inertial measurement unit 166. The acceleration data \vec{a} can include longitudinal, lateral and/or vertical acceleration components. The offset acceleration determination module 306 includes a processor executing instructions configured to determine an offset acceleration data \vec{a}′ based on the acceleration data \vec{a} and the road angle data \vec{θ} for compensating for any contribution to the measured acceleration data \vec{a} as a result of road gradient and/or road banking. In embodiments, the offset acceleration data \vec{a}′ can be calculated by a processor of the offset acceleration determination module 306 using equations 1 to 4 described above or other equations for determining an acceleration correction for the measured acceleration data \vec{a} based on road angle \vec{θ}. The offset acceleration determination module 306 may comprise an output interface for communicating the offset acceleration data \vec{a}′ to other modules.

The exemplary embodiment of FIG. 4 further includes a vehicle control module 310 that is configured to control at least one function of the vehicle 100 based on the offset acceleration data \vec{a}′. The vehicle control module 310 includes a processor that is configured to generate at least one vehicle control command taking into account the offset acceleration data \vec{a}′. The at least one vehicle control command may relate to automated power control, steering control and/or braking control through the power system 160, the steering system 150, and the braking system 155. Such control functions may include regenerative braking, following distance to other vehicles, avoiding obstacles or path planning for the vehicle 100.

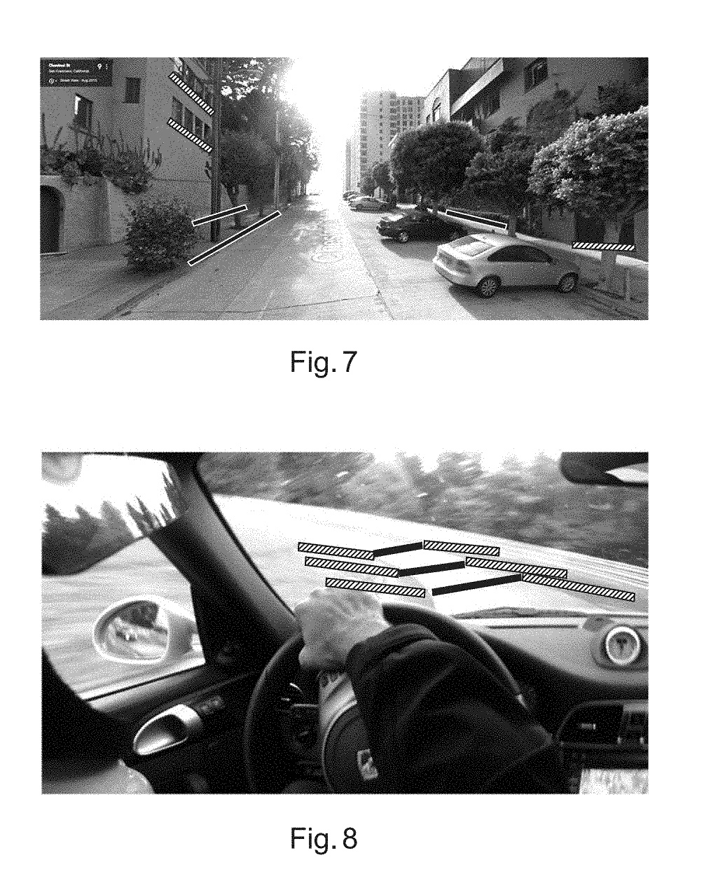

The road angle data \vec{θ} may be extracted from the enhanced digital map 184 in one embodiment. The road angle data \vec{θ} can be extracted from the enhanced digital map 184 as data representative of road angles or as image data that can be image processed as described below (particularly with reference to FIGS. 7 and 8) to determine the road angle data \vec{θ}. However, other embodiments may obtain the road angle data \vec{θ} through alternative schemes such as the level sensor 174 or through image or video data obtained by the cameras 101, 103 or obtained through the map 184. When the enhanced digital map 184 is being used, a map data extraction module 312 can be included as shown in the exemplary embodiment of FIG. 4. The map data extraction module 312 may include an interface for receiving GPS data through the GPS receiver 168 and a processor for interrogating the enhanced digital map 184 using the GPS data and extracting road angle data \vec{θ} from the enhanced digital map 184 that corresponds to the location of the vehicle 100. As explained above the road angle data \vec{θ} is being extracted directly in this embodiment rather than indirectly through road images that require subsequent analysis. The process of obtaining the road angle data \vec{θ} can include sending a request to the enhanced digital map (and a processor therefor) that includes the GPS data. The processor can interrogate the enhanced digital map and return the road angle data \vec{θ} (or images in an alternative embodiment).

In an additional or alternative embodiment, the road angle data \vec{θ} can be obtained through image or video data from the cameras 101, 103. In an alternative to the image or video data being obtained from the cameras 101, 103, it can be obtained by GPS interrogation of the enhanced digital map 184. In such embodiments, the vehicle control system 102 comprises a road image analysis module 304 and a road angle extraction module 302. In embodiments, the road image analysis module 304 comprises an input interface for receiving the image or video data and a processor operating an image analysis engine. In various embodiments, the image analysis engine is configured to determine at least one horizontal reference marker in image data and at least one road angle maker representing gradient and/or banking of the road. The image analysis engine may operate at least one image filter and at least one segmentation process to determine upon the horizontal reference and road angle markers. Exemplary horizontal markers can include horizontal roadside features including building and road infrastructure. For example, roadside walls, windows, balconies, etc. are representative of horizontal features that can be identified and marked by the analysis engine. Road angle markers can be determined based on curbs, e.g. curb tops, curb-road interface, pavement-building interface, road markings, and other road or roadside features. The road image analysis module 304 may include an output interface for communicating a result of image analysis to other modules, particularly an image including the horizontal reference markers and the road angle markers. In various embodiments, the road image analysis module 304 is configured to iteratively perform image analysis when enabled to allow iteratively updated acceleration data \vec{a} to be determined.

An example result of image analysis by the road image analysis module 304 is shown in FIG. 7 for determining road gradient angle. Here, horizontal or level road or roadside features have been marked as reference marks, which are shown using dashed lines. The horizontal road or roadside features include a line of windows on a building, and a wall feature. Road gradient markers, represented by bold solid lines, include hedgerows, curb tops and pavement building interface.

Another example result of image analysis by the road image analysis module 304 is shown in FIG. 7 for determining road banking angle. Here, the horizon/guardrail/base of road is used to identify horizontal. Horizontal marker lines (represented by dashed lines in the figure) are identified on radially opposed sides of the road, which are connected by a road angle line marker (shown in solid line).

Referring back to the exemplary embodiment of FIG. 4, the road angle extraction module 302 includes an input interface configured to receive marked image data from the road image analysis module 304 and a processor to determine at least one angle between the horizontal reference markers and the road angle markers. In this way, image derived road angle data \vec{θ} can be extracted. The road angle extraction module 302 may include an output interface for communicating the road angle data \vec{θ} to the offset acceleration determination module 306.

In the exemplary embodiment of FIG. 4, the road image analysis module 304, the road angle extraction module 302 and the map data extraction module 312 are provided in combination. In this way, road angle data \vec{θ} can be extracted from the enhanced digital map 184 when available. Should road the road angle data \vec{θ} not be available in the enhanced digital map 184, or the enhanced digital map 184 itself not be available, the road angle data can be derived from road image analysis through the road image analysis module 304 and the road angle extraction module 302. Further, a map storage module 308 is provided in exemplary embodiments, which includes an input interface to receive GPS data and road angle data \vec{θ} from the road angle extraction module 302. The map storage module 308 includes a processor and an output interface to coordinate storing or embedding the image derived road angle data \vec{θ} in the enhanced digital map 184 at a map location corresponding to the GPS data. The enhanced digital map 184 is thus populated with the road angle data \vec{θ} to reduce future image processing requirements.

Referring to FIG. 5, there is shown a dataflow diagram 400 illustrating features of the methods and systems described herein for determining and utilizing offset acceleration \vec{a}′ based on road angle data \vec{θ}, in accordance with an exemplary embodiment. In an exemplary embodiment, the processes and features of the data flow diagram 400 are implemented through the processor 172 executing computer program instructions. The processes and features of the data flow diagram 400 can be implemented through the modules of the vehicle control system 102 described above with reference to FIG. 4.

The dataflow diagram includes a process 402 of obtaining road angle data \vec{θ} according to various exemplary possibilities according to FIG. 5. In one option, the road angle data \vec{θ} is read from the level sensor 167. In another possibility, the road angle data \vec{θ} is extracted from the enhanced digital map 184. To do so, a data retrieval protocol may be used by which GPS data from GPS receiver 168 is sent to a search engine associated with the enhanced digital map 184. The enhanced digital map is interrogated by the search engine at a location corresponding to the GPS data to obtain any road angle data \vec{θ} or images embedded therein. Where images are returned, road angle data \vec{θ} is extracted by image processing as has been described above. In yet another possibility, the road angle data \vec{θ} is derived from image or video data from cameras 101, 103 as described further below.

In a process 414, acceleration data \vec{a} is obtained by reading such data from the inertial measurement unit 166.

The road angle data \vec{θ} obtained in process 402 and the acceleration data \vec{a} obtained in process 414 s used in a process 404 of determining offset acceleration \vec{a}′. In particular, the road angle data \vec{θ} and the acceleration data \vec{a} are used as inputs to a calculation for compensating influence of road gradient angle and/or road banking angle in lateral, longitudinal and/or vertical acceleration readings obtained from the inertial measurement unit 166. Exemplary calculations are shown by equations 1 to 4 described above.

In a process 406, the offset acceleration data \vec{a}′ determined in process 404 is used as an input for controlling at least one vehicle function 406. In particular, the offset acceleration data \vec{a}′ is used to determine at least one control command for the braking, steering and/or power system 150, 155, 160.

In an embodiment making use of road image data to derive road angle data \vec{θ}, processes 408, 410 are included. In process 408, image analysis processing is performed on road image or video data from the cameras 101, 103 or from images obtained by GPS based interrogation of the enhanced digital map 184. The image analysis processing identifies one or more horizontal reference features and one or more features indicative of road angle. Reference and road markers may be embedded in the road image data based on the identified one or more horizontal reference features and one or more features indicative of road angle, as described above.

In process 410, road angle data \vec{θ} is calculated based on the road image data that has been image processed in process 408. In particular, an angle is calculated between one or more horizontal reference markers and one or more road angle markers in the processed image data.

In some embodiments, process 412 may be included whereby calculated road angle data \vec{θ} obtained through processes 408 and 410 is stored in the enhanced digital map at a located identified by GPS data obtained from the GPS receiver 168.

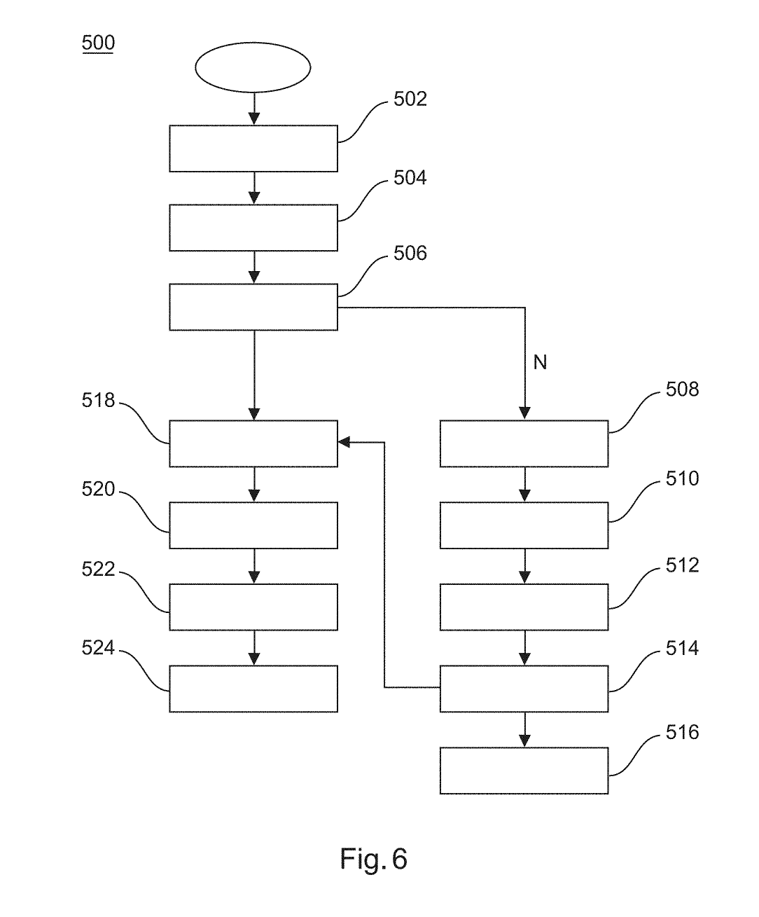

FIG. 6 is a flowchart of an exemplary method 500 of controlling a vehicle based on road angle and acceleration data as described herein. In embodiments, the method is computer implemented through a processor, computer readable instructions executed by the processor and data sources such as sensors and other hardware, as will become clear. The method 500 of FIG. 6 is described with respect to an example that obtains road angle data \vec{θ} from a combination of the enhanced digital map 184 and through image analysis of road images and video data from the cameras 101, 103. It should be appreciated, however, that the road angle \vec{θ} can additionally or alternatively be obtained by readings from the level sensor 167. In an embodiment, using a level sensor 167, the steps of the method 500 relating to extracting data from the map and road image analysis may be excluded. It should further be appreciated that the road images may be obtained from GPS based interrogation of the enhanced digital map 184.

The method 500 includes a step 502 of reading GPS data from the GPS receiver 168, in accordance with one embodiment. The GPS data serves as an input for a step 504 of interrogation of the enhanced digital map 184. The enhanced digital map 184 and associated processor implemented search engine returns either road angle data \vec{θ} or a no data flag indicating that no road angle data \vec{θ} is available for the map location corresponding to the GPS data.

In embodiments, step 506 determines whether road angle data \vec{θ} is available based on whether the no data flag is returned or whether road angle data is returned \vec{θ} by interrogating the enhanced digital map 184 in step 504. If road angle data \vec{θ} is available, it is used in a step 518 of obtaining road angle data \vec{θ} for subsequent processing. If no road angle data \vec{θ} is available from the enhanced digital map 184, road image analysis steps 508 to 516 are performed.

In step 508, road image or video data is read from the cameras 101, 103. In step 510, road image analysis is performed to simplify the image data for subsequent road angle data extraction steps 512, 514. In particular, image analysis step 510 may entail image filtering and segmentation processes. In step 512, horizontal reference markers and road angle markers are identified in the processed image data from step 510 as described above with reference to FIGS. 7 and 8. The reference markers may be in the form of lines. The horizontal markers may be identified based on road or roadside features that are generally horizontally oriented, such as building features, e.g. roof lines, window lines, door lines, roadside infrastructure features such as street lights, walls, road signs (which are generally vertical allowing horizontal to be derived) and natural features such as the horizon, amongst numerous possibilities. The road angle markers may be identified based on road or roadside features indicative of the road angle, such as road markings, curb features, pavement-building interface, etc. In step 514, based on the identified horizontal reference and road angle markers from step 512, road angle data \vec{θ} can be calculated using a trigonometric function, for example. The calculated road angle data \vec{θ} is established in step 518 as the road angle data \vec{θ} for subsequent calculations. In step 516, the road angle data \vec{θ} is stored in the enhanced digital map 184 using the GPS data to determine the correct location.

In various embodiments of the method 500, acceleration data \vec{a} is read from the inertial measurement unit 166 in step 520. In step 522, the accelerations data \vec{a} and the road angle data \vec{θ} serve as inputs for determining offset acceleration data \vec{a}′ according to processes described in the foregoing. The offset acceleration data \vec{a}′ is operable to control at least one autonomous function of the vehicle 100 in step 524.

The exemplary method 500 of FIG. 5 may be modified such that the road image analysis steps 508 to 516 are not conditional on road angle data \vec{θ} being available as required by step 506. Instead road image analysis operations could be run iteratively to accumulate road angle data \vec{θ} persistently during a journey. In such an embodiment, the road angle data \vec{θ} could be used to refine data already present in the enhanced digital map 184 or the enhanced digital map 184 could not be used. In another alternative just the enhanced digital map 184 could be used as the source of road angle data \vec{θ} so as to forego the road image analysis step 508 to 516 or, where images are obtained from the map that require analysis to derive road angle data \vec{θ}, so as to forego obtaining images from the cameras 101,103. In yet another embodiment, the road angle data \vec{θ} can be obtained by any one of or any combination of road image analysis, reading the level sensor 167 and extracting from the enhanced digital map 184.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A vehicle control system, comprising:
an inertial measurement unit comprising at least one sensor for measuring at least one measured acceleration component of a vehicle; and
a processor configured to obtain at least one of road gradient and road bank angle of a road being travelled by the vehicle;
wherein the processor is configured to control at least one vehicle function responsive to the at least one acceleration component of the vehicle and the at least one of road gradient and bank angle.

2. The vehicle control system of claim 1, wherein the processor is configured to determine at least one gravity acceleration component resulting from the at least one of road gradient and the road bank angle.

3. The vehicle control system of claim 1, wherein the processor is configured to offset the at least one measured acceleration component with at least one corresponding gravity acceleration component resulting from the at least one of road gradient and road bank angle.

4. The vehicle control system of claim 1, comprising a global positioning system unit for measuring global position data of the vehicle, wherein the processor is configured to obtain the at least one of road gradient and road bank angle based on the global position data.

5. The vehicle control system of claim 1, wherein the processor is configured to access a map of the road and obtain the at least one of road gradient and road bank angle based on the map of the road.

6. The vehicle control system of claim 5, wherein the map has embedded therein the at least one of road gradient and road bank angle.

7. The vehicle control system of claim 5, wherein the map includes imaging of the road and the processor is configured to derive the at least one of road gradient and road bank angle from the imaging of the road.

8. The vehicle control system of claim 1, comprising at least one sensor for measuring the at least one of road bank angle and road gradient.

9. The vehicle control system of claim 8, wherein the at least one sensor is at least one of a camera, a LIDAR device and a level sensor.

10. The vehicle control system of claim 1, comprising an imaging device for obtaining road images, wherein the processor is configured to derive the at least one of road bank angle and road gradient from the road images.

11. The vehicle control system of claim 10, wherein the processor is configured to perform road feature analysis on the road images to determine at least one horizontal road feature and at least one feature indicative of at least one of road bank angle and road gradient and to determine the at least one of road bank angle and road gradient based on the road feature analysis.

12. The vehicle control system of claim 1, wherein the at least one vehicle feature comprises at least one of automated steering, automated braking and automated speed and/or acceleration control.

13. A method of controlling at least one function of a vehicle, the method comprising:
measuring at least one measured acceleration component of a vehicle; and
obtaining at least one of road gradient and road bank angle of a road being travelled by the vehicle;
controlling at least one vehicle function responsive to the at least one acceleration component of the vehicle and the at least one of road gradient and bank angle.

14. The method of claim 13, comprising determining at least one gravity acceleration component resulting from the road gradient and the road bank angle, offsetting the at least one measured acceleration component with the at least one gravity acceleration component resulting from the road gradient and the road bank angle corresponding to the at least one road acceleration component.

15. The method of claim 13, comprising obtaining road images, deriving the at least one of road bank angle and road gradient from the road images by performing road feature analysis on the road images to determine at least one horizontal road feature and at least one feature indicative of at least one of road bank angle and road gradient and deriving an angle between the at least one horizontal road feature and the at least one feature indicative of at least one of road bank angle and road gradient angle.

16. The method of claim 13, comprising measuring global position data of the vehicle, accessing a map of the road using the global position data and obtaining the at least one of road gradient and the road bank angle based on the map of the road using at least one of:
road feature analysis on road images embedded in the map and extracting road gradient and/or
road bank angle data embedded in the map.

17. A vehicle, comprising:
an inertial measurement unit comprising at least one sensor for measuring at least one measured acceleration component of a vehicle; and
a processor configured to obtain at least one of road gradient and road bank angle of a road being travelled by the vehicle;
wherein the processor is configured to control at least one vehicle function responsive to the at least one acceleration component of the vehicle and the at least one of road gradient and bank angle.

18. The vehicle of claim 17, wherein the processor is configured to derive the at least one of road bank angle and road gradient from road images by performing road feature analysis on the road images.

19. The vehicle of claim 18 and at least one of:
wherein the processor is configured to access a road map to obtain the road images; and
wherein the vehicle comprises an imaging device for obtaining the road images.

20. The vehicle of claim 17, wherein the processor is configured to determine at least one gravity acceleration component resulting from the road gradient and the road bank angle, and wherein the processor is configured to offset the at least one measured acceleration component with at least one gravity acceleration component resulting from the road gradient and the road bank angle corresponding to the at least one measured acceleration component.
